(19) United States
(12) Patent Application Publication
(10) Pub. No.: US 2009/0109568 A1
(43) Pub. Date: Apr. 30, 2009

(54) Thermal elements for controlling and manipulating thermal pitch static attitude (PSA)

(75) Inventors: Manuel A. Hernandez, San Jose, CA (US); Niraj Mahadev, Milpitas, CA (US); Yugraj S. Aujla, San Jose, CA (US); Yen Fu, San Jose, CA (US); Nelson Troung, Milpitas, CA (US); Tai Dang, Milpitas, CA (US)

Correspondence Address: SAILE ACKERMAN LLC, 28 DAVIS AVENUE, POUGHKEEPSIE, NY, 12603, US

(73) Assignee: SAE Magnetics (HK) Ltd.

(21) Appl. No.: 11/981,126

(22) Filed: Oct. 31, 2007

(51) Int. Cl. G11B 33/14

(52) U.S. Cl. 360/97.02

(57) ABSTRACT

The sensitivity of the fly height of a HDD (hard disk drive) recording head to temperature variations can be greatly reduced, eliminated or controlled in a manner to enhance HDD performance under various temperature conditions by affixing a thermal element to the HGA (head gimbals assembly) flexure. The thermal element in this invention is a deposited, patterned layer of DLC (diamond-like carbon) that has a coefficient of thermal expansion that is less than that of the stainless steel flexure. As a result of the placement of this thermal element on the flexure, the temperature-induced angular variations of PSA (pitch static attitude) can be made to compensate for temperature-induced changes in the slider crown curvature, thereby reducing or eliminating fly height variations due to temperature.

### BACKGROUND OF THE INVENTION

1. Field of the Invention

This invention relates to the fabrication of hard disk drives (HDD), particularly to a method of controlling physical changes in HDD components due to thermal fluctuations.

2. Description of the Related Art

With the introduction of the hard disk drive (HDD) in a wide range of consumer applications, there has been a constant shrinkage in the dimensions of all of its various components. Along with this reduction in the size of the HDD components has come an increasing density of information that must be written and read on the hard disk. Because of this combination of factors and, in particular, because the read/write head and its slider assembly have shrunk several orders of magnitude, certain reliability issues that seriously affect the slider/drive manufacturer have been raised.

Traditionally, the direction taken in trying to achieve high density information storage and retrieval has been to decrease the magnetic spacing between the disk and the slider. FIG. 1 is a schematic illustration showing a prior art suspension-mounted slider (collectively termed a “head gimbals assembly (HGA)”) positioned above a rotating magnetic hard disk (40) during hard disk-drive (HDD) operation at a given, nominal normal operating temperature. A flexure (10) is fastened (12) by solder balls (for example) to a load beam (15) from which protrudes a small dimple (17) that exerts a force against a slider (20). The flexure mounting pad (11) holds the slider (20) at a PSA angle (25) above the surface of a magnetic disk (40), producing a flying height (50) between the edge of the slider and the disk when the disk is in motion. The angle (25) between the slider and the disk when the disk is not rotating is termed the pitch static attitude, PSA, of the slider. The angle may be denoted θ, and in the present illustration that angle is approximately zero indicating that the mounting pad (11) is substantially horizontal and parallel to the load beam (15). As is illustrated schematically, the PSA angle in this flexure illustration is substantially due to the tilt of the slider mounting pad (11) portion of the flexure relative to the horizontal attitude of the load beam (15). In FIG. 1, the PSA angle θ is drawn as substantially a zero angle, since the mounting pad (11) is drawn parallel to the load beam (15). Note that this PSA is drawn for simplicity of viewing only and is meant to indicate a condition of normal operating temperature.

The surface (22) of the slider that faces the disk is denoted its air bearing surface, or ABS. This surface has a side-facing profile (as shown here) that is slightly curved (slightly convex in the illustration), with the region of greatest curvature (24) of the ABS being termed the “crown.” The combination of the curvature of the ABS crown and the tilt of the PSA is, in large part, responsible for the “fly height” (50) of the transducer above the disk, which is the magnetic spacing between the disk and the transducer under operating conditions. Note, in this illustration, for simplicity, it is assumed that the read/write transducer is located at the edge of the slider that is distal to the solder balls (12).

The present level of information storage on the disk surface necessitates a magnetic spacing on the order of nanometers, which introduces challenges to the manufacturer in terms of maintaining very tight control over slider fly height as well as over the shape profile of the slider surface. Both fly height and shape are parameters that are sensitive to the back-end manufacturing process and they must be very tightly controlled to insure efficient performance of the HDD.

One of the important reliability factors in HDD performance is the ability of the HDD to perform well under changing temperatures imposed by stringent operating conditions, particularly temperatures in a hot operating environment that have been increased, for example, from 80° C. to 100° C. and temperatures in a cold operating environment that have been decreased, for example, from 5° C. to −30° C. Under such conditions several things happen to the physical parameters of the HGA that adversely affect the flying height and, therefore, the ability of the system to read the densely stored information on the disk. Two of these parameters are relevant to the present invention. One is the crown of the slider ABS, which was discussed above. As the temperatures increase, the HGA crown changes in the negative direction from what it is at room temperature. Thus, the slider profile changes significantly as the crown of the slider surface acquires a lesser curvature due to thermal stresses, causing the flying height to decrease. The opposite effect is also adverse to HGA performance. As the temperature decreases, the crown changes in a positive direction from what it is at room temperature. This increase in the curvature of the crown forces the flying height to increase relative to what it is at room temperature. The phenomenon of crown change as a function of temperature is most likely a result of thermal stresses imposed on the slider by expansion and contraction of the HGA to which it is fastened. This effect can cause disk drives to fail.

The second parameter of relevance to this invention is pitch static attitude or PSA. As the temperature under which the HDD is to operate rises, the angle θ, measuring PSA relative to the horizontal, of some HGA's change in the positive direction from what it is at room temperature. This, particular situation is illustrated in FIG. 2. This positive PSA delta θ (25) lowers the flying height (50) and, thereby, brings the transducer portion of the slider closer to the disk surface and lowers the magnetic spacing. Conversely, as the temperature decreases, the PSA angle changes in the negative direction, causing the flying height to become higher, also adversely affecting the HDD performance. Of particular concern is the fact that both of these thermally driven parameter changes operate in the same direction, thus reinforcing their adverse impact on HDD performance.

FIG. 2 shows the same prior art HGA as FIG. 1, except that the situation of the HDD operation is not the normal ambient temperature illustrated in FIG. 1, but is a higher temperature condition. This situation causes a positive delta θ (25) in the PSA and that increased angle produces a corresponding decrease in the fly height (50). This decrease in fly height also includes the same effect caused by the less sharply curved crown (24) that further exacerbates the effects of the positive delta θ (25) as the slider flies above the rotating disk (40).

As noted above, a possible explanation for the change of slider profile is the difference in the coefficient of thermal expansion of the slider and flexure and other elements in the HGA, the coefficient being less for the slider than the materials of the HGA. These coefficient differences could give rise to stresses that develop in the HGA during temperature variations and are transferred to the slider body. Once these stresses appear in the slider, the profile of the slider's ABS will be changed, as indicated in FIG. 2.

Reducing the sensitivity of the slider profile to temperature-induced changes can be done at the wafer level (before individual sliders are formed). At this level, the slider can be re-designed and/or new wafer materials could be developed that are less sensitive to temperature variations. This would be an expensive solution to the problem. Another solution, possibly equally expensive and time consuming, would be to re-design the suspension and adhesive materials fastening the slider to the suspension to better accommodate thermal stresses. While these approaches are feasible, they require extensive time and monetary expenditures.

The need to control flexure temperature variations is recognized in the prior art. U.S. Pat. No. 7,152,303 (Childers et al) discloses localized heating in forming flexure legs so that PSA is not changed by thermal exposure. U.S. Pat. No. 6,760,182 (Bement et al) shows deposition of shape memory alloys to compensate for temperature change to fly height.

The present invention proposes to reverse the direction of PSA changes in such a manner as to counterbalance the effects of crown change. In this way, the flying height will remain constant throughout the range of operating temperatures encountered in HDD operations. In fact, the method of the invention can also be applied in such a way as to reverse the trend in fly height change caused by crown variations so that the HGA would actually fly lower at cold temperatures and higher at high temperatures.

### SUMMARY OF THE INVENTION

The first object of the present invention is to provide a method of fabricating an HGA assembly, including a suspension mounted slider, whereby thermally induced changes in shape of the ABS slider profile (crown) are counterbalanced by controlled thermally induced changes in PSA of the suspension. Thus, overall, the HGA is rendered less sensitive to thermal variations and, in consequence, the fly height of the slider-mounted read/write head remains constant over a wide range of temperatures and the read and write performance of the read/write head is not adversely affected by changes in the magnetic spacing between the head and the disk surface.

The second object of the present invention is to provide such a method wherein thermal variations of crown shape are counterbalanced by compensatory thermally induced changes in PSA

The third object of the present invention is to provide a method of controlling thermally induced variations in the PSA of a HGA.

A fourth object of the present invention is to provide such a method that is insensitive to other environmental variables, such as humidity and altitude.

A fifth object of the present invention is to provide such a method that can be optionally applied at various stages of manufacturing.

The objects of this invention will be achieved by the use of thermal elements. A thermal element is defined as an element that is applied to a structure, by deposition on or bonding to that structure, to control and/or manipulate the physical changes that the structure undergoes when subjected to a thermally changing environment. In the present invention, the thermal element will exert that control by the application of forces to the structure as a result of a differential in thermal expansion or contraction between the element and the structure to which it is applied.

All materials undergo geometric changes when subjected to a thermal load. As a result of this phenomenon, each material is assigned a coefficient of thermal expansion, Cₜ, which expresses the relationship between the dimensional change of the material and the temperature change to which it is subjected. Generally when a material is exposed to an increase in temperature, its various dimensions increase and the material expands. When the material is exposed to a decrease in temperature, most typically it will contract. Metals have a high coefficient of thermal expansion, some more than others, while materials such as ceramics have a low coefficient. Diamond is the material that changes least under thermal loads and it has a Cₜ (diamond)=2×10⁻⁶/° C. Stainless steel has a coefficient Cₜ(SS)=16.5×10⁻⁶/° C., whereas copper has a coefficient Cₜ(Cu)=17×10⁻⁶/° C. The basic idea of this invention, as described in its preferred embodiment, is to affix a thermal element to a portion of an HGA structure, preferably to a portion of the HGA flexure to which the slider is attached, such that the thermally induced dimensional changes of the element counteracts the effects of the thermally induced dimensional changes of the structure. In the preferred embodiment, the change in PSA angle (delta θ) will be made to become positive when the operating temperature decreases and will be made to become negative when the operating temperature increases. This will tend to counterbalance the opposite thermal tendency of the crown profile of the slider. To accomplish this action, the thermal element is preferably formed as a patterned layer of material having a low coefficient of thermal expansion, such as the DLC (diamond-like carbon) layer that is applied to the ABS of the slider and which has a coefficient that is substantially that of diamond itself. If such a material element is attached at an appropriate position, by either deposition or some other means of bonding to the (typically stainless steel) flexure, then the element's reactions to temperature change will modify the overall changes in the flexure in such a way as to achieve the objects of the invention.

### BRIEF DESCRIPTION OF THE DRAWINGS

The objects, features, and advantages of the present invention are understood within the context of the Description of the Preferred Embodiment as set forth below. The Description of the Preferred Embodiment is understood within the context of the accompanying figures, wherein:

FIG. 1 is a schematic side view of a suspension mounted prior art slider showing the magnetic spacing between the slider and a disk surface during normal operating temperatures.

FIG. 2 is a schematic side view of a suspension mounted prior art slider showing the decreased magnetic spacing between the slider and a disk surface during high temperature operating temperatures.

FIG. 3a is a schematic view of the backside of an exemplary prior art flexure structure showing the structure without thermal elements.

FIG. 3b is a schematic view of the backside of the same flexure structure showing the placement of thermal elements on the structure in accord with this invention.

FIG. 4 is a schematic side view of a flexure structure that includes a thermal element that compensates for a crown shape change.

FIG. 5a-FIG. 5b are graphical representations of data showing the effects of temperature variations on a suspension under conditions in which thermal elements are absent.

FIG. 5c is a graphical representation of data showing the effects of temperature variations on a suspension having thermal elements applied to its back side.

### DESCRIPTION OF THE PREFERRED EMBODIMENTS

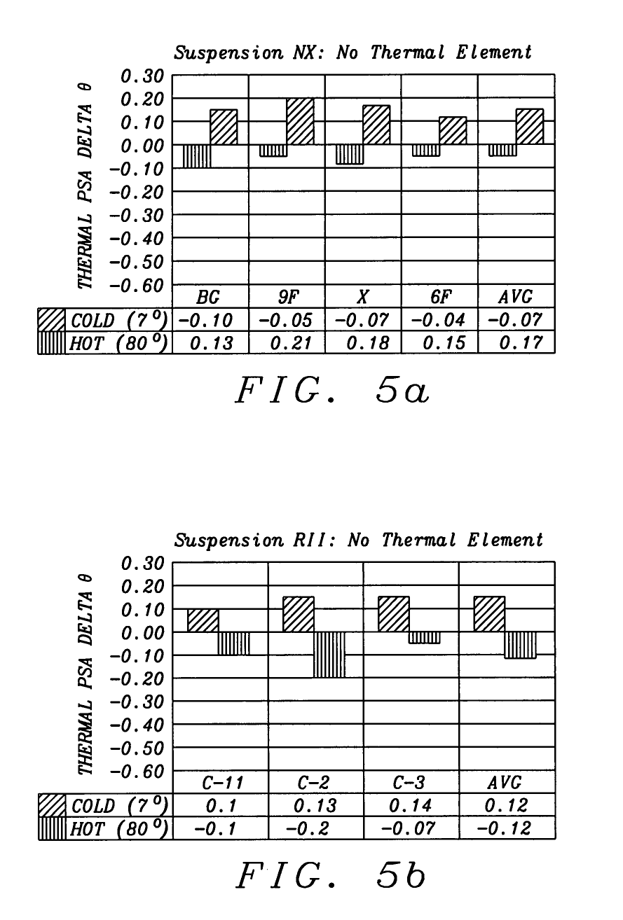

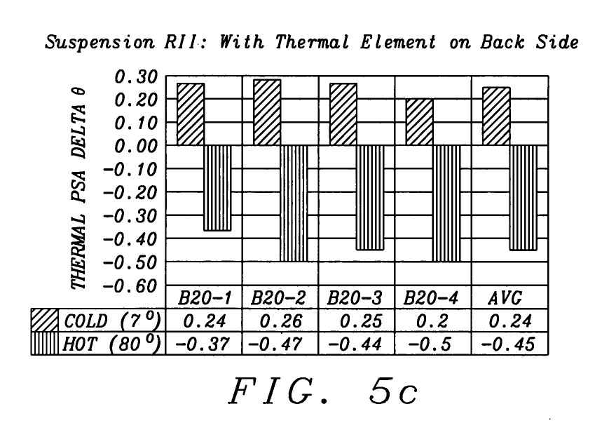

The preferred embodiment of the present invention teaches a method of fabricating a suspension mounted slider within a HDD, whereby the application of thermal elements to portions of a flexure surface control the sensitivity of the HGA to changes in slider fly height caused by thermal variations of the flexure PSA. The thermal elements, thereby, also counterbalance, in a compensatory manner, the effects of slider crown variations that are also caused by thermal variations. In this invention, the effect of the thermal element is to alter the amount of variation of the PSA, as measured by the PSA angular deviation, delta θ, that the flexure provides to the mounted slider. In general, by proper choice of thermal element material, position and shape, the PSA can be made to change more than it would without the presence of the thermal element, or less than it would without the presence of the thermal element. In fact, as shown in FIGS. 5a-5c, a positive change in PSA in the absence of the thermal element can be converted to a negative change with the addition of the thermal element and vice-versa. In what follows, the phrase “PSA delta θ” refers to the change in angle between the ABS surface of the slider and a horizontal plane (or surface plane of a disk beneath the slider) without inclusion of the effects of variation in the crown shape of the slider itself. It is further understood that it is the combined effects of the temperature induced crown shape variation and the PSA delta θ, that cause the total change in slider fly height that the present invention seeks to control. It is also understood that the effect of the thermal element on the flexure does not require the presence of the slider in the sense that the variations in PSA are a result of stresses that arise from differences in Cₜ between the thermal element and the slider materials.

Referring to FIG. 3a there is shown a schematic drawing of an exemplary flexure of the type to which the addition of thermal elements will achieve the objects of this invention. The backside of the flexure, opposite to the side to which the slider is fastened, is shown in FIG. 3a. The exemplary flexure as shown in both of these figures would be formed of stainless steel and would include a slider mounting pad ( 11) and outriggers (40) symmetrically disposed to opposite sides of the slider mounting pad. The outriggers provide flexibility to the structure by enabling the slider mounting pad to flex relative to the disk surface. The outriggers also provide support for electrically conducting leads (60) that carry the read/write head (mounted in the slider) signal to external circuitry. These leads are shown as visible through openings in the flexure, because they are placed along the opposite side of the flexure as that shown. Preferably, as shown in FIG. 3b, the thermal element is formed as a layer of DLC (80), shown shaded on the figure, approximately 1 micron in thickness, that is deposited on the backside (opposite to the disk-facing side) of the outriggers. It is noted that a thermal element may be affixed to a flexure by various means, deposition being a preferred means when the element is DLC as provided herein, and it may be affixed at various times during the HDD fabrication process. In this preferred embodiment, as shown in FIG. 3b and as noted above, the thermal element is a layer of DLC (80) deposited on the flexure by a means such as chemical vapor deposition, but other forms of deposition are equally possible or, alternatively, the thermal element may be formed separately and affixed to the flexure by adhesives or bonding. The DLC has the additional advantages of being a material already used in the HDD fabrication process and of being a material known to be resistive to corrosion, oxidation and other effects of humidity and non-thermal ambient conditions. It is further noted that the precise shape of a flexure can be dictated by the vendor that supplies it, so the patterning and positioning of the thermal element may vary somewhat depending on the flexure being used. Nevertheless, given the general shape of a flexure that is dictated by its function and that enables it to achieve its intended purpose, such as the exemplary shape in FIG. 3b, the flexure positioning shown in FIG. 3b will accomplish the objects of the invention.

It is noted that a thermal element of substantially the size and shape of that illustrated in FIG. 3b was applied to a flexure of this particular shape and material structure. Without the addition of such a thermal element, the flexure acquired a negative PSA delta θ under a negative change in temperature of −50° C. By experiment, it was shown that the addition of the thermal element was capable of producing a positive change in PSA (a positive delta θ) of approximately 1.28 degrees under a change in temperature of −50° C. Further experimental results are discussed below.

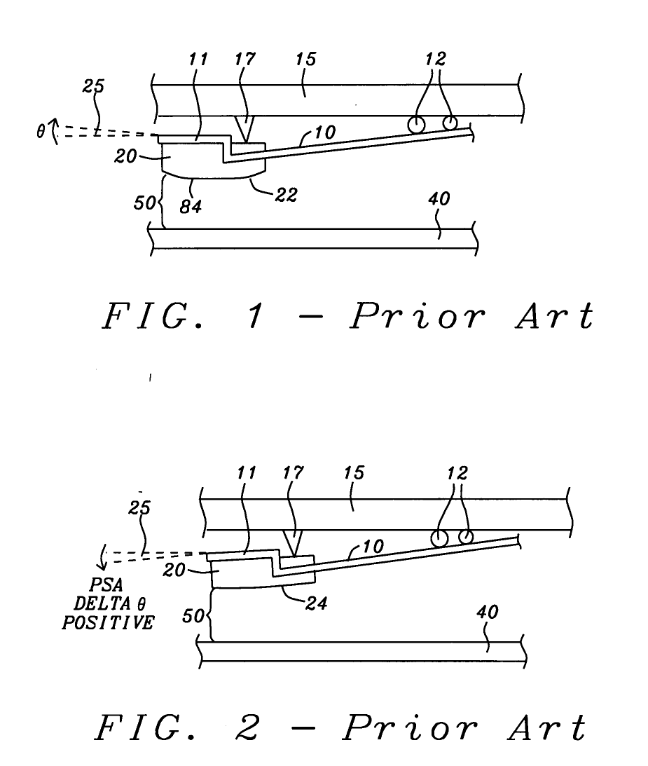

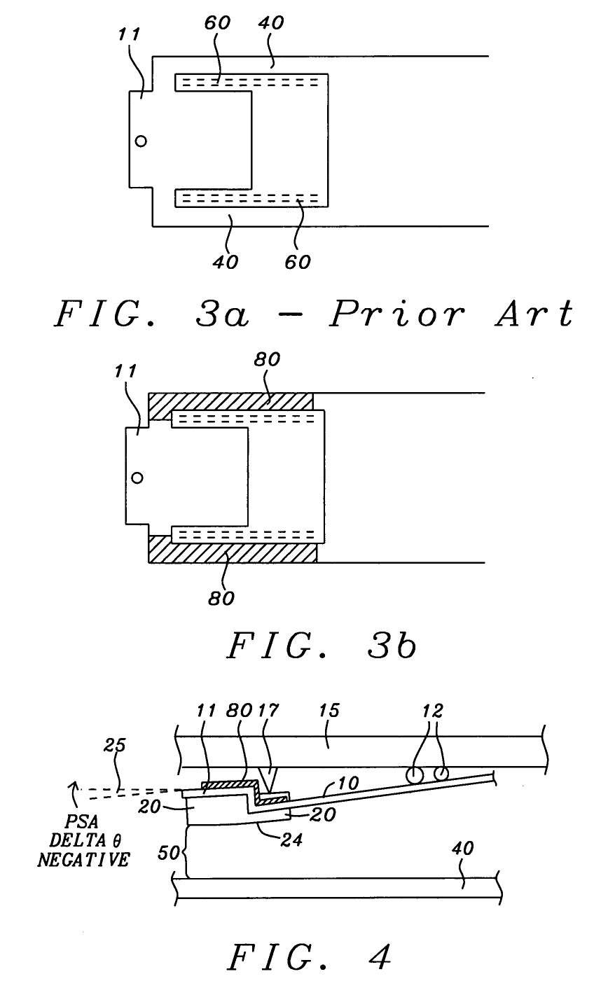

Referring next to FIG. 4, there is shown, schematically, in an illustration analogous in all respects to those in FIGS. 1 and 2, a flexure (10) on which a thermal element (80) has been affixed to the outrigger backside surfaces in a manner similar to that shown in FIG. 3b. Note that for ease of viewing, the side view of this exemplary flexure does not precisely correspond to the backside view in FIG. 3b, but it is schematically illustrative of the invention. On the assumption that the HDD in this figure has been subjected to an elevated temperature, as in FIG. 2, the crown (24) of the slider (20) and the ABS curvature are shown flattened. However, the thermal element now causes the flexure PSA delta θ (25) to become negative, so that the PSA change compensates for the crown change and the flying height (50) is substantially the same as in FIG. 1.

Referring next to the graphical data represented in FIG. 5a, there is shown the thermally induced PSA angular delta θ for typical flexure types which exhibit positive deltas at an 80° C. temperature and negative deltas at a 7° C. temperature and to which no thermal elements have been attached. Referring to FIG. 5b, there is shown the angular delta θ for typical flexures that exhibit negative deltas at an 80° temperature and positive deltas at a 7° temperature and to which no thermal elements have been applied. Referring finally to FIG. 5c, there is shown the effect of the addition of thermal elements to the backside surface (surface opposite the surface on which the slider is mounted) of the same flexures of FIG. 5a. As is indicated by the figures, the elements offer a great variation in their control of delta θ. It is to be noted that the role of the thermal element may not be simply to eliminate the PSA delta θ at some given ambient temperature or temperature range (i.e., not necessarily to set delta θ=0), the action of the thermal element may in fact be to add an additional positive or negative PSA delta θ in order to enhance the read/write performance of the HGA during thermal loading (actual thermal operating conditions).

As is understood by a person skilled in the art, the preferred embodiment of the present invention is illustrative of the present invention rather than being limiting of the present invention. Revisions and modifications may be made to methods, processes, materials, structures, and dimensions through which is formed a suspension mounted slider with reduced thermal sensitivity of its fly height due to variations in crown and PSA, while still providing such a suspension mounted slider, formed in accord with the present invention as defined by the appended claims.

What is claimed is:

1. An HGA with controlled sensitivity to temperature variations comprising:
a flexure having a disk-facing side and a backside opposite to said disk-facing side; and
a thermal element affixed to or formed on said flexure; and
a slider, mounted on said disk-facing side of said flexure, whereby,
at a given operating temperature said slider has a given crown and said flexure provides said slider with a given PSA angle; and wherein
said thermal element provides a controlled variation of said flexure-provided PSA angle as a result of temperature variations relative to said given operating temperature.

2. The HGA of claim 1 wherein said controlled variation is an increase or a decrease in said flexure PSA angle as a result of a given temperature variation of said HGA, relative to the increase or decrease of said flexure PSA angle as a result of the same said temperature variation of said HGA when said thermal element is not affixed to said flexure.

3. The HGA of claim 1 wherein the combination of controlled PSA angle variation and temperature induced variations of said slider crown shape is compensatory, whereby an overall variation in slider fly height as a result of said temperature variations is minimized.

4. The HGA of claim 1 wherein said flexure is formed of a material having a coefficient of thermal expansion Cₜ(f) and said thermal element is formed of a material having a coefficient of thermal expansion Cₜ(te) and Cₜ(f) does not equal Cₜ(te).

5. The HGA of claim 4 wherein said flexure is formed of stainless steel and said thermal element is formed of DLC.

6. The HGA of claim 5 wherein said thermal element is a patterned layer of DLC formed on a portion of said flexure.

7. The HGA of claim 1 wherein said flexure includes a slider mounting pad and outrigger portions.

8. The HGA of claim 7 wherein said thermal elements are affixed to said outrigger portions on a backside of said outrigger portions.

9. The HGA of claim 8 wherein said thermal elements are layers of DLC deposited on said backside of said outrigger portions.

10. A method of controlling the temperature sensitivity of the recording head of a HDD comprising:
providing a HDD including a flexure having a disk-facing side and a backside opposite to said disk-facing side;
forming a thermal element on a surface of said flexure;
affixing a slider-mounted a recording head to the disk-facing side of said flexure.

11. The method of claim 10 wherein said thermal element controls variations of a fly height of said recording head that result from temperature variations of said HDD.

12. The method of claim 11 wherein said controlled variations comprise an increase or a decrease in a PSA of said flexure as a function of a given temperature variation, relative to the increase or decrease of said flexure PSA as a function of the same said temperature variation when said thermal element is not formed on said flexure.

13. The method of claim 12 wherein the combination of controlled flexure PSA variation and temperature induced variations of said slider crown is compensatory, whereby an overall variation in slider fly height as a result of temperature variations is minimized.

14. The method of claim 13 wherein the overall variation in slider fly height as a result of temperature variations is controlled so as to enhance the operation of the HDD during operating conditions.

15. The method of claim 10 wherein said flexure is formed of a material having a coefficient of thermal expansion Cₜ(f) and said thermal element is formed of a material having a coefficient of thermal expansion Cₜ(te) and Cₜ(f) does not equal Cₜ(te).

16. The method claim 15 wherein said flexure is formed of stainless steel and said thermal element is formed of DLC.

17. The method of claim 16 wherein said thermal element is a patterned layer of DLC formed on a surface of a portion of said flexure.

18. The method of claim 10 wherein said flexure includes a slider mounting pad and outrigger portions.

19. The method of claim 18 wherein said thermal elements are affixed to surfaces of said outrigger portions on the backsides of said outrigger portions.

20. The method of claim 19 wherein said thermal elements are layers of DLC deposited on backside surfaces of said outrigger portions.
